(19) United States
(12) Patent Application Publication
(10) Pub. No.: US 2003/0041261 A1
(43) Pub. Date: Feb. 27, 2003

(54) Method and apparatus for coordinating computer messages and attachments

(76) Inventor: David S. Shukan, San Marino, CA (US)

Correspondence Address: Law Office of Leland Wiesner, 1144 Fife Ave., Palo Alto, CA, 94301, US

(21) Appl. No.: 10/224,996

(22) Filed: Aug. 21, 2002

Related U.S. Application Data
(60) Provisional application No. 60/314,954, filed on Aug. 25, 2001.

(51) Int. Cl. H04L 9/00

(52) U.S. Cl. 713/200

(57) ABSTRACT

A method of processing electronic mail messages includes analyzing the message to determine whether it is likely to be missing an intended attachment, and providing feedback based upon the analysis at least in cases in which the electronic mail message is considered likely to be missing an intended attachment. Further, the method for processing electronic mail messages includes analyzing the text of the message and if indicated checking whether an attachment is present, or checking whether an attachment is present and if indicated analyzing the text of the message. Alternatively, a designation by the composer of the message as to intent to include an attachment may be used instead of an analysis of the message text.

### CROSS REFERENCE TO RELATED APPLICATIONS

This application is related to Provisional Application Serial No. 60/314,954 by David S. Shukan, filed Aug. 25, 2001, entitled System And Method For Avoiding Sending Computer Messages Lacking Intended Attachments, and herein incorporated by reference for all purposes.

### BACKGROUND OF THE INVENTION

Aspects of the present invention relate to the coordinating of electronic mail messages and their attachments.

Many different computer applications allow for the sending of electronic mail messages over the Internet or computer networks. Electronic mail can be integrated into larger applications, or can be the primary operation or function in a stand-alone electronic mail client. Examples of stand-alone electronic mail clients include Microsoft's Outlook, Eudora, and web-based services such as Hotmail. Larger applications and enterprise software such as customer service management (CRM) often integrate full-function electronic mail functionality to facilitate and compliment their primary operating features. In the event the enterprise or larger application does not have integrated electronic mail functionality, a stand-alone electronic mail client can be substituted. In either scenario, an electronic mail client portion allows for an electronic message to be sent to a recipient.

The sender composes the electronic mail message using the built-in features of the electronic mail client, typically including commands to format the text portion of the message body, and to transmit the message to the recipient when completed. When composing an electronic mail message with a electronic mail client, the sender enters the message header information (including the recipient's electronic mail address and message subject line), as well as composes the message body, including the text portion.

Most electronic mail clients also allow for not only a text portion to be sent in the message body, but for one or more files from a computer, such as documents and machine-language executable applications, to be “attached” by the sender in a message body. These files, commonly known as attachments when they are included in or with the message body of an electronic mail message, can be sent with or without a text portion of the message body.

In conventional electronic mail clients, when a sender wishes to attach a file while composing a message, the sender must first depress a particular button or invoke a menu command. Next, the electronic mail client displays a box allowing the sender to select which attachments the sender wishes to send along with the electronic mail message. Once the sender has selected the appropriate attachments, the sender can then continue composing the message or proceed with sending it. Unfortunately, invoking the file attachment process while composing the message often disrupts the sender's train of thought and message content. For example, if the file attachment process is performed prematurely before the message is complete, the sender may not know which or how many attachments to include in the message. Consequently, the person sending the message may delay—and ultimately forget—to include the attachments to be sent with the electronic message.

Sending a message without an attachment, at a minimum, wastes time and effort. Further, when the information in the attachment is not delivered to the recipient, the sender and recipient must realize the error and work together to communicate and resend the message with the missing attachment. Regardless of whether the sender or recipient work to resend the missing attachment, sending a message without a needed attachment can be embarrassing to the sender, and can also leave the recipient with a bad impression. If the attachment is time-sensitive, greater harm may occur when there is insufficient time to resend the message. These are just some of the problems conventional systems present when coordinating the sending of electronic mail messages with attachments.

### BRIEF DESCRIPTION OF THE DRAWINGS

FIG. 1 is a block diagram of an electronic mail system used by one implementation of the present invention;

FIG. 2 is a flow diagram providing the operations used to compose a message in accordance with one implementation of the present invention;

FIG. 3 is a flow diagram depicting the operations used by one implementation of the present invention to determine when an attachment is missing;

FIG. 4 is a flow diagram of operations used with another implementation of the present invention comparing words in an electronic mail message with a database of attachment keywords to determine whether an attachment should be present;

FIG. 5 is a flow diagram of the operations for gathering attachment keywords in a database in accordance with one implementation of the present invention;

FIG. 6 is a flow diagram of the operations in one implementation of the present invention for analyzing statistical word patterns associated with attachments in an electronic mail message;

FIGS. 7A-C represent different views of a user interface for managing messages and attachments designed in accordance with one or more aspects of the present invention;

Like reference numbers and designations in the various drawings indicate like elements.

### DETAILED DESCRIPTION

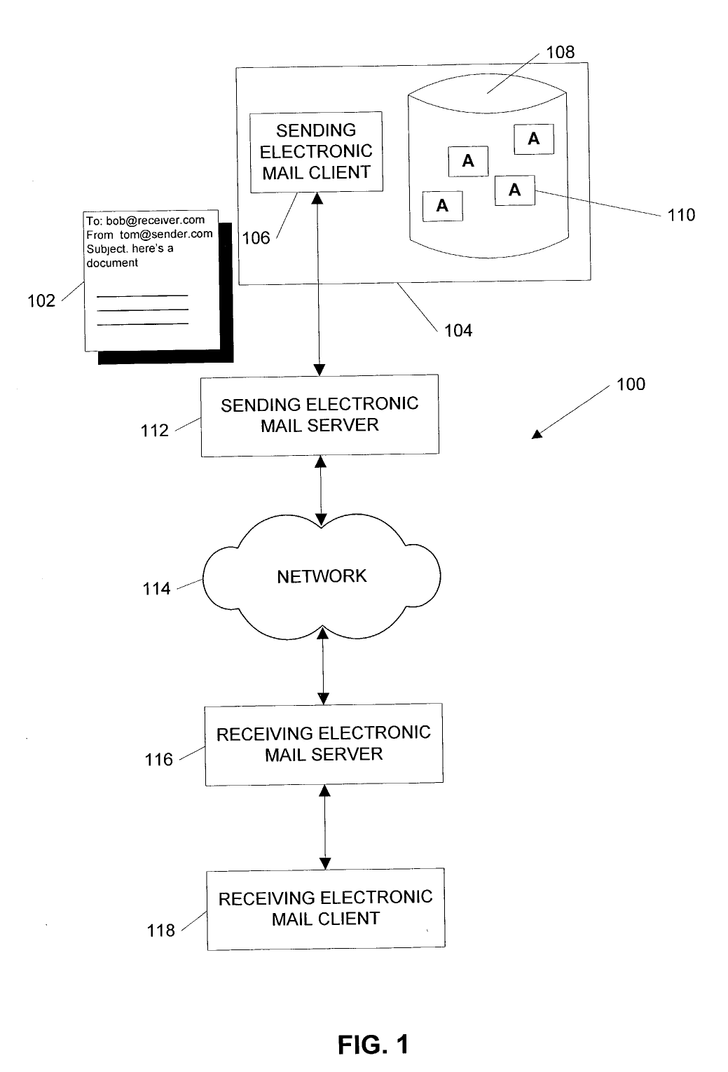

FIG. 1 is a block diagram of an electronic mail system 100 for implementing various aspects of the present invention. Typically, an electronic mail system 100 includes one or more individual electronic mail messages 102 often composed on a sending computer system 104. Sending computer system 104 also includes sending electronic mail client 106 and a file database system 108 further containing attachments 110.

Sending electronic mail client 106 transmits electronic mail message 102 through to a sending electronic mail server 112, which, in turn, transmits electronic mail message 102 through a computer network 114 and onto a receiving electronic mail server 116. Computer network 114 includes without limitation a private corporate local area network, the Internet, and other types of computer networks.

Receiving electronic mail server 116 delivers electronic mail message 102 to a receiving electronic mail client 118 according to the address associated with electronic mail message 102.

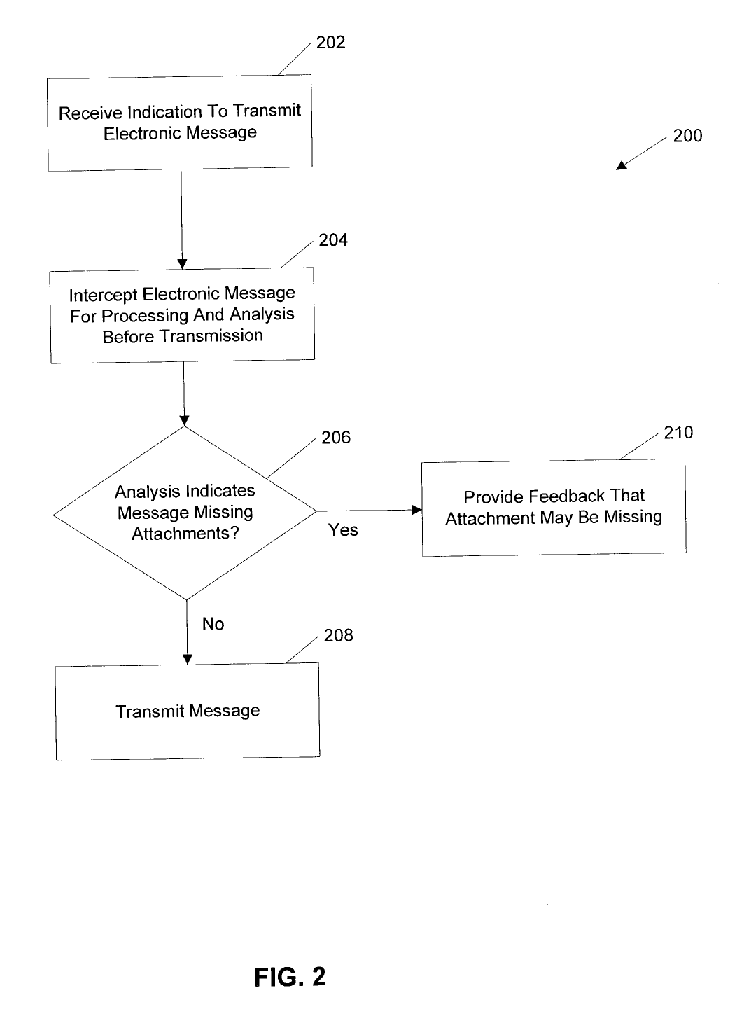

FIG. 2 is a flow diagram providing the operations used to compose a message in accordance with one implementation of the present invention. First, an electronic mail message is composed and an indication is received to transmit the electronic mail message to a recipient (202). Instead of sending it immediately, the electronic mail message is intercepted for processing and analysis (204). The content of the message is analyzed in accordance with one or more implementations of the present invention to determine whether one or more attachments are missing or if the message is ready for transmission (206). In one implementation, this analysis occurs transparently; the attachment-checking process occurs automatically when a user composes a message.

If the message has one or more requisite attachments it is transmitted (208). Alternatively, the message is also transmitted when there are no attachments associated with the message if the analysis and processing indicates that no attachments are likely to be missing (208). Otherwise, if the analysis indicates that the electronic mail message is likely to be missing one or more attachments, feedback provided to the sender indicates there may be one or more missing attachments(210).

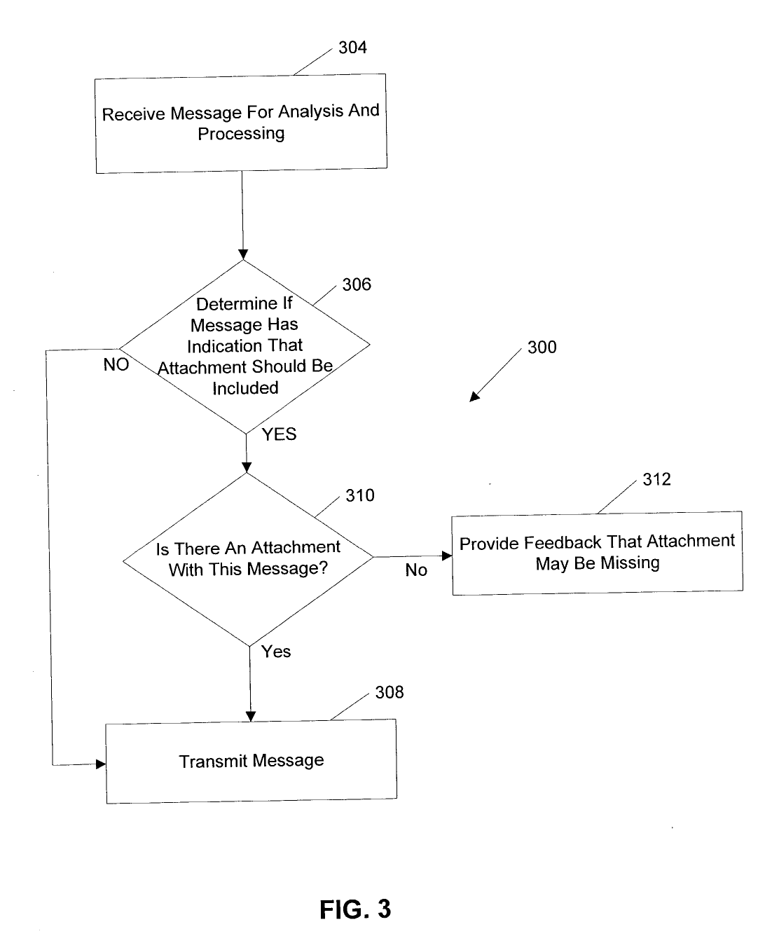

FIG. 3 is a flow diagram depicting the analysis and processing associated with one implementation of the present invention for determining whether an electronic mail message is likely to have missing attachments. An electronic mail message is first received for analysis and processing (304). The analysis detects if the message has an indication that an attachment should be present (306).

For example, an indication that an attachment should be present can be inserted by a user composing a message, in accordance with one implementation of the present invention. In this implementation, the user right clicks on a mouse or pointing device during message composition to indicate that the message is intended to include an attachment. This enters the indication in or with the message that can be recognized by implementations of the present invention. Optionally, an icon or image can also be placed in the visual representation of this message providing a positive visual confirmation.

In another implementation of the present invention, an electronic mail message may be analyzed and processed automatically. Details on this implementation are described in further detail later herein.

In either of these or other implementations, if the message does not have an indication to include an attachment, the message can be transmitted without further processing associated with the message attachments (308). If there is an indication that the message should have an attachment, the message is checked to see if an attachment is present or is missing (310). If an attachment is present, the message is transmitted (308) and further analysis terminates. However, if an attachment is not present, the sender receives feedback noting this condition (312). For example, a user may receive a pop-up menu indicating that an attachment appears to be missing and a prompt for the user to select the attachment from a file system or other storage device. Another implementation of the present invention may further analyze the indication in combination with the message content and historical information to automatically suggest one or more attachments to include with the message.

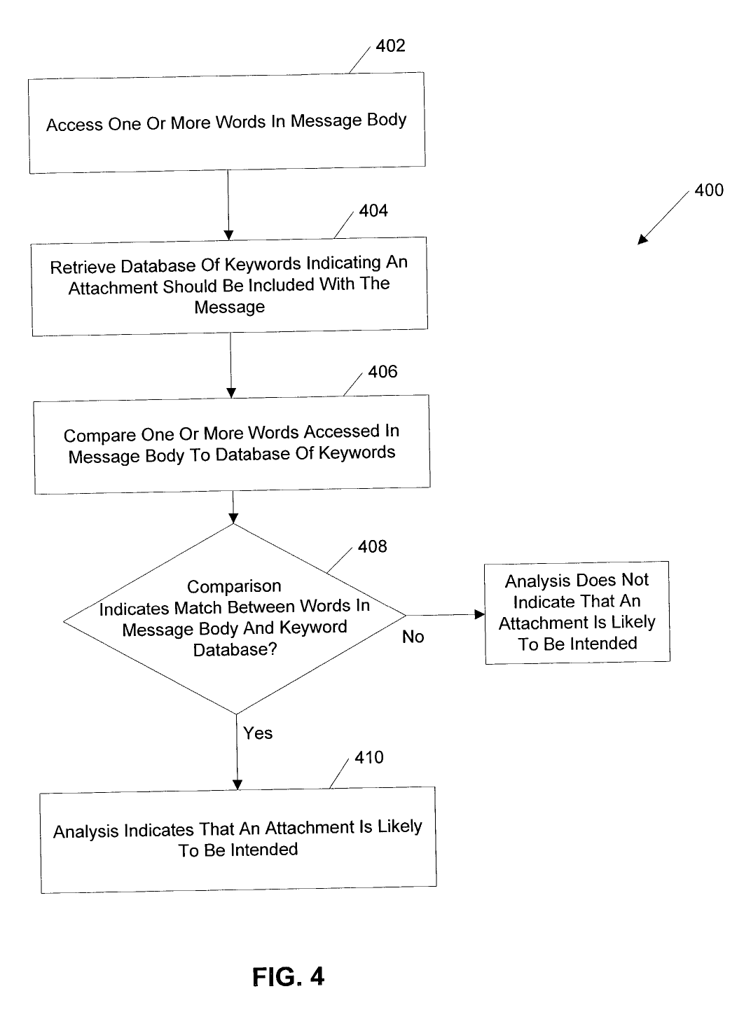

FIG. 4 is a flow diagram showing the operations in one implementation of the present invention that reference keywords in a keyword database to determine whether to include an indication in the message. Initially, a reference operation 400 accesses one or more words in the message body of an electronic mail message and parses them for further processing (402). Next, reference operation 400 retrieves a keyword database having keywords associated with the presence of an attachment (404).

For example, the keyword database can be supplied by a user, can be compiled automatically over time in accordance with one or more implementations of the present invention, or created using other processes and operations. The user can also take an automatically generated or existing keyword database and edit it as needed over time by adding or deleting keywords. In one implementation, these keywords include words such as: “attach”, “attached”, “attaching”, attachment”, “encl.”, “enclose”, “enclosed”, “enclosing”, “enclosure”, “enclosures”, “enclosing”, “to this message”, “with this message”, “files”, “here is”, “documents attached”, “attached files”, “included attachment”, “included file”, and any other keywords indicating that an attachment should be included as part of the electronic message, although not all such words need be used. Additionally, such keywords may include “wildcard” characters representing arbitrary letters or strings (e.g., “attach!”), and may include combinations of words not necessarily appearing adjacent to each other.

One or more words from the message body are then compared against the keyword database (406). Depending on the implementation, a single word in the message is compared with a single word in the keyword database or, alternatively, one or more words in the message are compared with one or more words in the keyword database. In either of these or other implementations, a comparison is made between the combination of words in the message body and keywords in the keyword database (408); if the comparison indicates a match in the keyword database then reference operation 400 provides an indication that an attachment should be included with the electronic mail message (410). Alternatively, the comparison may not provide an indication to include an attachment if the one or more words from the message body word are not present in the keyword database. Accordingly, this process continues as additional words are retrieved from the message body and processed accordingly (402).

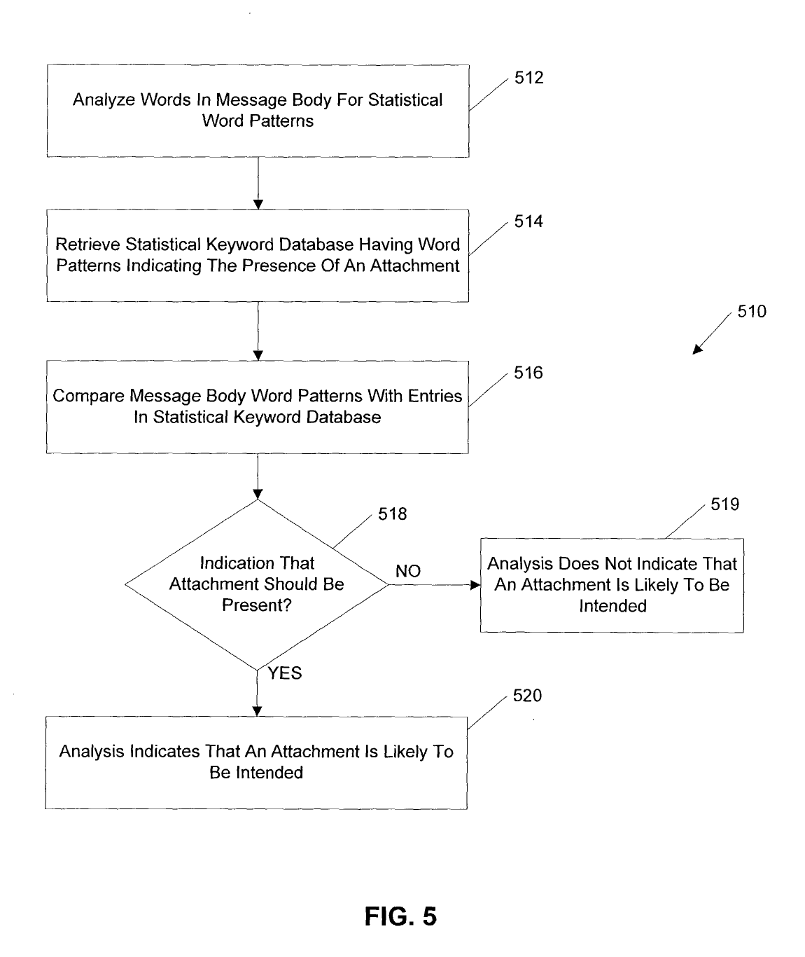

In FIG. 5, another implementation of the present invention performs a statistical analysis of word patterns in the message body to determine whether to provide an indicator that a message should have an attachment. This implementation of the invention compares word patterns in the message body with a statistical keyword database to determine if an attachment indicator should be inserted in the message. Accordingly, the words in the message are parsed and statistically analyzed for one or more word patterns (512). For example, statistical analysis may include generating a histogram of words occurring in the message. In addition to word frequency, the relative positions of the words in the message are gathered for further statistical processing.

A statistical keyword database having word patterns indicating the presence of an attachment is retrieved (514). Information in the statistical keyword database is collected from numerous other electronic messages having attachments. Different combinations of words are more or less likely to indicate that a particular electronic message also includes an attachment. By collecting these word patterns over a long period of time, the accuracy of the information aggregated in the statistical keyword database increases. Details on creating a statistical keyword database in accordance with implementations of the present invention is described in further detail later herein.

A statistical comparison is made between the results of the statistical analysis of the message body and that of the word patterns in the statistical keyword database (516). If there is a statistical indication that an attachment should be present (518), an indication is provided (520). Otherwise, an indicator for including an attachment is not included (519) and the message can be transmitted. Alternative implementations of this system could have the statistical instances of word patterns of message bodies without attachments stored in a database instead, or in addition to, the implementation described herein. These alternative implementations would use these statistical instances of word patterns in messages without attachments to compare against messages to determine the likelihood that the messages should not have an attachment.

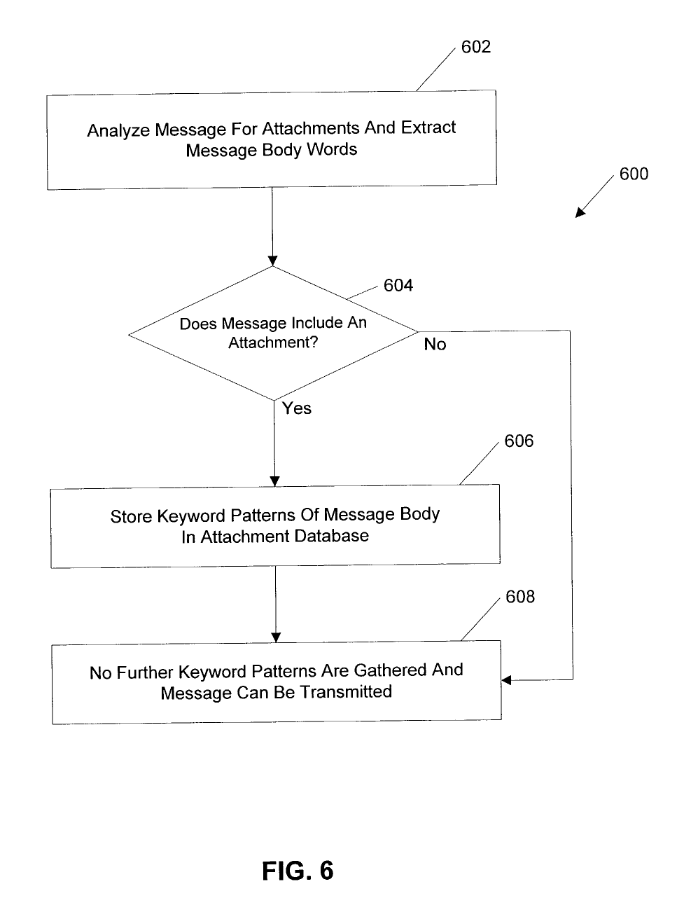

FIG. 6 is a flow diagram of the operations for gathering statistical database keywords for use with one or more implementations of the present invention. For example, these operations gather information used for comparison with the message contents to determine when an attachment indication is appropriate. Regardless of whether an attachment is present, all outgoing messages are passed through system 600 before being transmitted.

Initially, the system analyzes the outbound message, identifying the presence of attachments and extracting the message body text (602). If the message does not already include an attachment (604), no further keyword information from the message is gathered and the message can be transmitted (608). If the message does include an attachment (604), the statistical instances of word patterns in the message body are saved in a statistical keyword database as word patterns that likely are associated with the presence of an attachment (606). In another implementation, the statistical word pattern database can be generated and stored through the use of artificial intelligence techniques, such as neural networks.

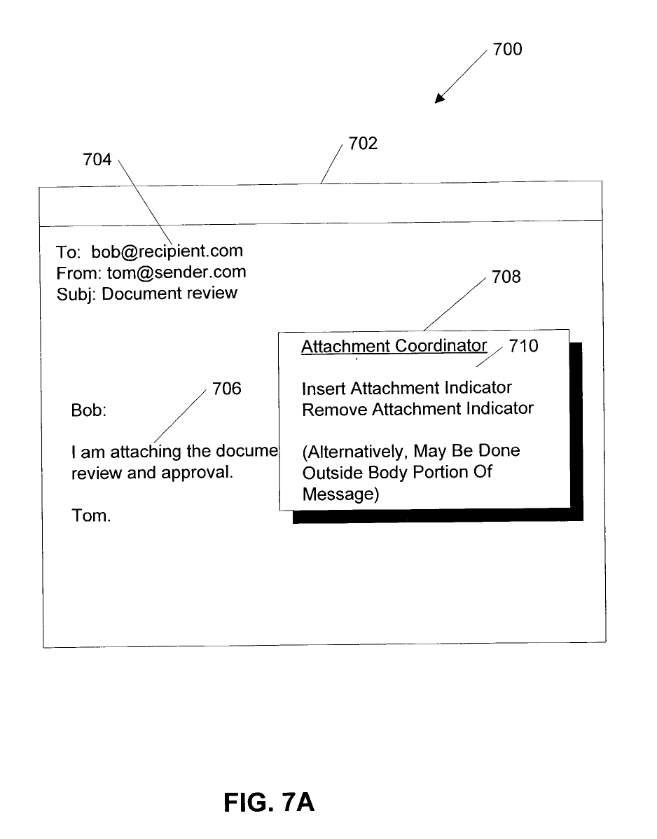

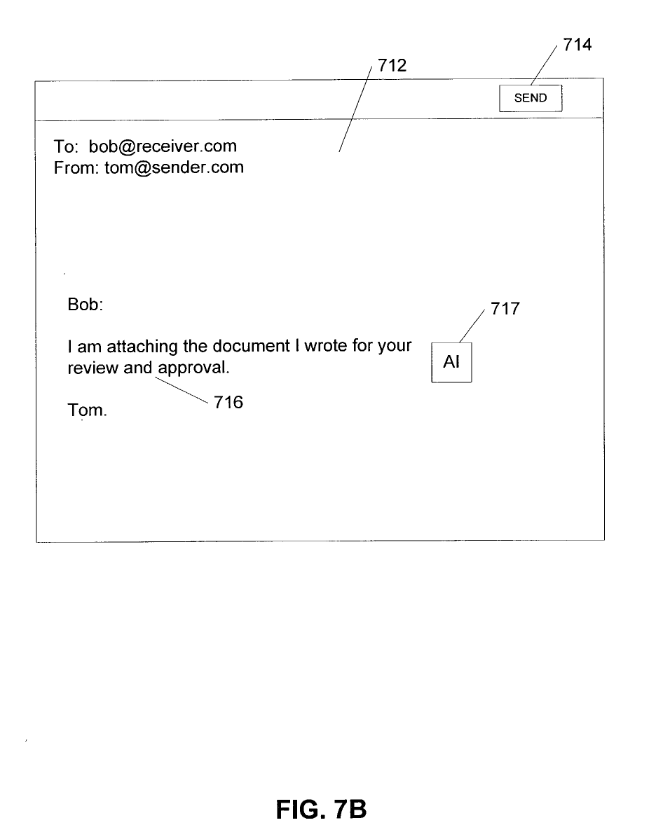

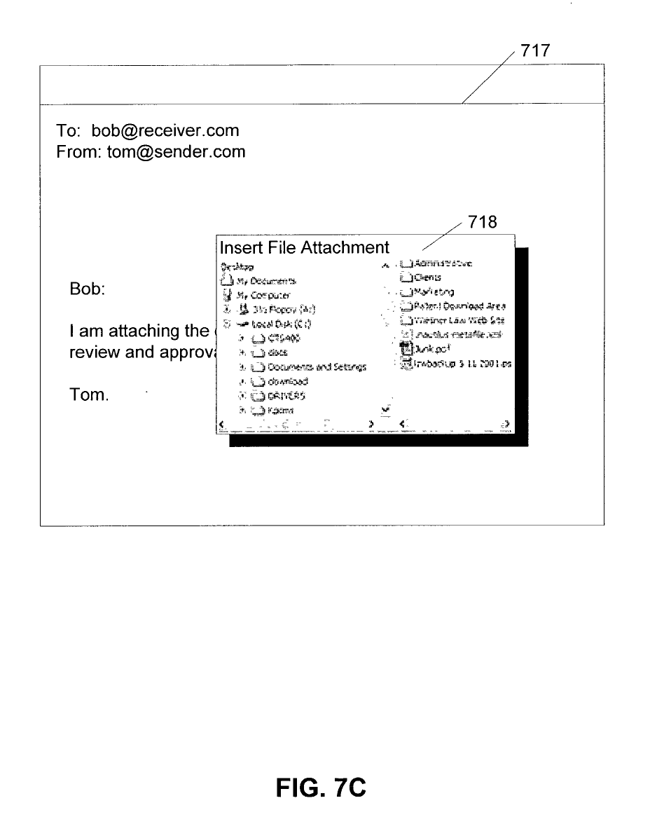

FIGS. 7A-7C shows a user interface in one implementation of the present invention. In FIG. 7A, an electronic mail message is composed by the sender in message data input screen 700. Additional commands are invoked by the sender through function bar 702. Fields in the message include the message header 704 having the sender's and recipient's email addresses, the message subject line, and text portion 706. While composing text portion 706, if the sender decides to include an attachment, the sender performs a command such as a right-mouse click that causes a dialog menu 708 to appear, allowing the sender to toggle attachment indicator menu item 710 to signal that an attachment should be included with the message.

FIG. 7B shows the message data input screen 712 after the sender has finished composing the message and has indicated that the message should be transmitted by clicking send button 714. In one implementation, attachment indicator 717 provides a visual indication of the attachment indicator inserted in the message. In an alternate implementation, the indicator for an attachment is not displayed within the electronic mail message and attachment indicator 717 is omitted.

FIG. 7C shows the message data input screen 716 once the sender indicates that a message should be transmitted. Implementations of the present invention analyze and process the message before it is transmitted. Based on this analysis, an indicator inserted in the message indicates that at least one additional attachment should be attached inserted in the message. Accordingly, file attachment dialog box 718 is presented for the sender to specify the file attachment to associate with the message before transmission.

While specific embodiments have been described herein for purposes of illustration, various modifications may be made without departing from the spirit and scope of the invention. Accordingly, the invention is not limited to the above-described implementations, but instead is defined by the appended claims in light of their full scope of equivalents.

What is claimed is:

1. A method of processing electronic mail messages comprising:
analyzing the electronic mail message to determine whether it is likely to be missing an intended attachment; and
providing feedback based upon the analysis at least in cases in which the analysis indicates that the electronic mail message is likely to be missing an intended attachment.

2. The method of claim 1 wherein at least some of the text of the electronic mail message is intercepted and processed by a sending mail client.

3. The method of claim 1 wherein at least some of the text of the electronic mail message is intercepted and processed by a sending mail server.

4. The method of claim 1 wherein the analyzing further comprises:
comparing at least some of the text of the message with a word or words to determine whether the message is likely to be missing an intended attachment.

5. The method of claim 4 wherein the word or words used in the comparison are contained in a keyword database having words typically used when an attachment is included with a message.

6. The method of claim 5 wherein a user can add keywords and delete keywords from the keyword database.

7. The method of claim 1 wherein the analysis further comprises:
determining whether the message has an attachment; and,
sending the message without performing analysis on the text of the message as to determine whether an attachment is likely to be intended, when the determination indicates that the message already has an attachment.

8. The method of claim 1 wherein the analyzing further comprises:
comparing at least some of the text of the message with one or more words or word patterns to determine whether the message is likely to be missing an intended attachment.

9. The method of claim 8 wherein the one or more word patterns are compared with a statistical keyword database having probabilities associated with combinations of one or more words or word patterns from previous messages having attachments.

10. The method of claim 1 wherein the analyzing further comprises:
processing at least some of the text of the message for use in a statistical keyword database when the message includes one or more attachments.

11. The method of claim 10 wherein the use in a statistical keyword database is accomplished using artificial intelligence.

12. The method of claim 1 wherein feedback is provided in the form of an electronic mail message.

13. The method of claim 1 wherein feedback is provided in the form of an error message.

14. The method of claim 1 wherein feedback is provided through a prompt to specify one or more attachments.

15. The method of claim 1 wherein feedback further comprises:
determining which attachment or attachments to include when the analysis indicates that the message is likely to be missing an intended attachment; and
prompting for the selection of one or more of the attachments in response to the determination.

16. The method of claim 1 further comprising:
receiving a designation, before or during composition of the message, that the message is intended to include an attachment, and wherein the analysis includes determining whether such designation is present.

17. The method of claim 1 further comprising:
receiving a designation, before or during composition of the message, that the message is not intended to include an attachment, and wherein the analysis includes determining whether such designation is present.

18. The method of claim 1 wherein the analysis is performed transparently to the user.

19. A computer program product, tangibly stored on a computer-readable medium, for processing electronic mail messages comprising instructions that:
analyze the electronic mail message to determine whether it is likely to be missing an intended attachment; and
provide feedback based upon the analysis at least in cases in which the analysis indicates that the electronic mail message is likely to be missing an intended attachment.

20. An apparatus for processing electronic mail messages comprising:
a processor;
a memory having instructions capable of being executed on the processor that analyze the electronic mail message to determine whether it is likely to be missing an intended attachment, and provide feedback based upon the analysis at least in cases in which the analysis indicates that the electronic mail message is likely to be missing an intended attachment.
